(19) United States
(12) Patent Application Publication
(10) Pub. No.: US 2009/0045968 A1
(43) Pub. Date: Feb. 19, 2009

(54) Utility Outlets Capable of Presenting Images

(75) Inventor: Roland Schoettle, Freeport GBI (BS)

Correspondence Address: FULBRIGHT & JAWORSKI L.L.P, 2200 ROSS AVENUE, SUITE 2800, DALLAS, TX, 75201-2784, US

(73) Assignee: Optimal Innovations Inc., Bridgetown (BB)

(21) Appl. No.: 12/168,769

(22) Filed: Jul. 7, 2008

Related U.S. Application Data
(60) Provisional application No. 60/956,279, filed on Aug. 16, 2007.

(51) Int. Cl. G08B 5/00

(52) U.S. Cl. 340/691.6

(57) ABSTRACT

Systems and methods in which utility outlets present images of a premises to the occupant of the premises. The images are presented to the occupant when there is an alarm condition. The images provided by the utility outlets are easily accessible to the occupant of the premises because utility outlets are pervasive in most buildings.

### CROSS-REFERENCE TO RELATED APPLICATIONS

This application claims priority from U.S. Provisional Patent Application No. 60/956,279, entitled “UTILITY OUTLETS CAPABLE OF PRESENTING IMAGES” and filed Aug. 16, 2007, the disclosure of which is hereby incorporated herein by reference. The present application is related to co-pending, and commonly assigned U.S. patent application Ser. No. 10/094,743, Attorney Docket No. 74268/P005US/10506911, entitled “HYBRID FIBER/CONDUCTOR INTEGRATED COMMUNICATION NETWORKS;” U.S. patent application Ser. No. 11/512,742, Attorney Docket No. 74268/P008US/10606747, entitled “HYBRID FIBER/CONDUCTOR INTEGRATED COMMUNICATION NETWORKS;” U.S. patent application Ser. No. 11/683,304, Attorney Docket No. 74268/P012US/10609934, entitled “SYSTEMS AND METHODS FOR LINKING UTILITY CONTROL DEVICES;” U.S. patent application Ser. No. 11/683,327, Attorney Docket No. 74268/P013US/10609935, entitled “SYSTEM AND METHOD FOR INFRASTRUCTURE REPORTING;” U.S. patent application Ser. No. 11/683,298, Attorney Docket No. 74268/P014US/10614006, entitled “LIGHT SWITCH USED AS A COMMUNICATION DEVICE;” U.S. patent application Ser. No. 11/683,308, Attorney Docket No. 74268/P015US/10614005, entitled “SYSTEM AND METHOD FOR PREMISES MONITORING USING WEIGHT DETECTION;” U.S. patent application Ser. No. 11/923,176, Attorney Docket No. 74268/P015CP1/10704955, entitled “SELF LEARNING AUTOMATION SYSTEM;” U.S. patent application Ser. No. 11/683,326, Attorney Docket No. 74268/P016US/10614296, entitled “ANTICIPATORY UTILITY CONTROL DEVICE;” U.S. patent application Ser. No. ______, Attorney Docket No. 74268/P016CP1/10704956, entitled “ANOMALY-BASED PREMISE CONTROL;” U.S. patent application Ser. No. 11/683,335, Attorney Docket No. 74268/P017US/10614295, entitled “PLUG AND PLAY UTILITY CONTROL MODULES;” U.S. Patent Application No. 60/956,279, Attorney Docket No. 74268/V022.0/10712693, entitled “UTILITY OUTLETS CAPABLE OF PRESENTING IMAGES;” U.S. patent application Ser. No. 11/683,354, Attorney Docket No. 74268/P025US/10704959, entitled “LIGHT SWITCH POWER SUPPLY;” U.S. Patent Application No. 60/956,314, Attorney Docket No. 74268/V026.0/10712694, entitled “UTILITY OUTLETS AS A SECURITY SYSTEM;” U.S. Patent Application No. 60/940,010, Attorney Docket No. 74268/V027.0/10706725, entitled “LIGHT SWITCH AS A SECURITY HUB;” U.S. Patent Application No. 60/940,015, Attorney Docket No. 74268/V028.0/10706810, entitled “UTILITY OUTLETS AS REMOTE CONTROL REPEATERS;” U.S. patent application Ser. No. ______, Attorney Docket No. 74268/P029US/10704963, entitled “TEMPERATURE DETECTIONS AND CALCULATIONS OUTLETS,” the disclosures of which are hereby incorporated herein by reference.

### TECHNICAL FIELD

The current application relates to utility outlets and, more specifically, to the use of utility outlets to capture and create images for display to an occupant of a premises.

### BACKGROUND OF THE INVENTION

A high proportion of premises today are fitted with alarm systems. Typically, when an alarm system goes off, there is some indication by the system as to where the alarm was triggered. This indication is usually provided by one or two panels which shows a number lit up which corresponds to the area where the alarm was triggered. Most occupants of a premises, however, would like to know who or what triggered the alarm, in addition to where it was triggered. Current alarm systems, however, do not provide, to the user, information about the cause of the alarm. Further, the panels that currently provide information to the occupan, as to where the alarm was triggered are located in few places and usually in only one or two places in the premises. There is a need, therefore, to provide to occupants of a premises more information than just where an alarm was triggered and, further, to provide this information to all locations where the occupant may be located within the premises.

### BRIEF SUMMARY OF THE INVENTION

The present invention is directed to products, systems and methods for providing an occupant of a premises with images of the cause of an alarm condition within the premises. Because utility outlets are pervasive in most modern premises, it is opportune to use utility outlets as a means of capturing and communicating, to the occupant, the cause of an alarm condition within the premises.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is one embodiment of the current invention showing a block diagram of a utility outlet.

FIG. 2 illustrates how a plurality of utility outlets are used to effect one embodiment of the current invention.

FIG. 3 illustrates one embodiment of the current invention in the form of a flow chart.

### DETAILED DESCRIPTION OF THE INVENTION

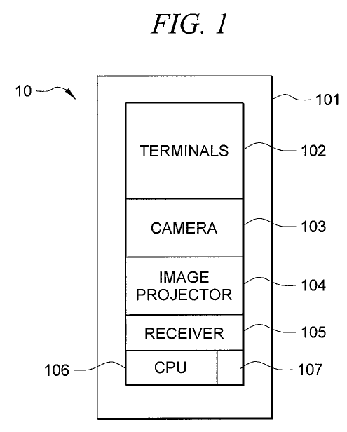

FIG. 1 is one embodiment of the current invention showing a block diagram of a utility outlet 10. Utility outlet 10 has a housing 101 that contains terminals 102 for connecting a device to a power supply. A receiver 105 is located within housing 101 for receiving an alarm condition signal and signals of images. Utility outlet 10 may also include, within housing 101, a camera 103 and/or an image projector 104. The camera 103 is capable of capturing an image of the surroundings in which utility outlet 10 is located. The camera 103 may be activated to capture an image by a signal received by receiver 105. Image projector 104 can project an image to a user in proximity to utility outlet 10 as a result of an image signal received by receiver 105. Utility outlet 10 may also include a central processing unit 106 with memory 107.

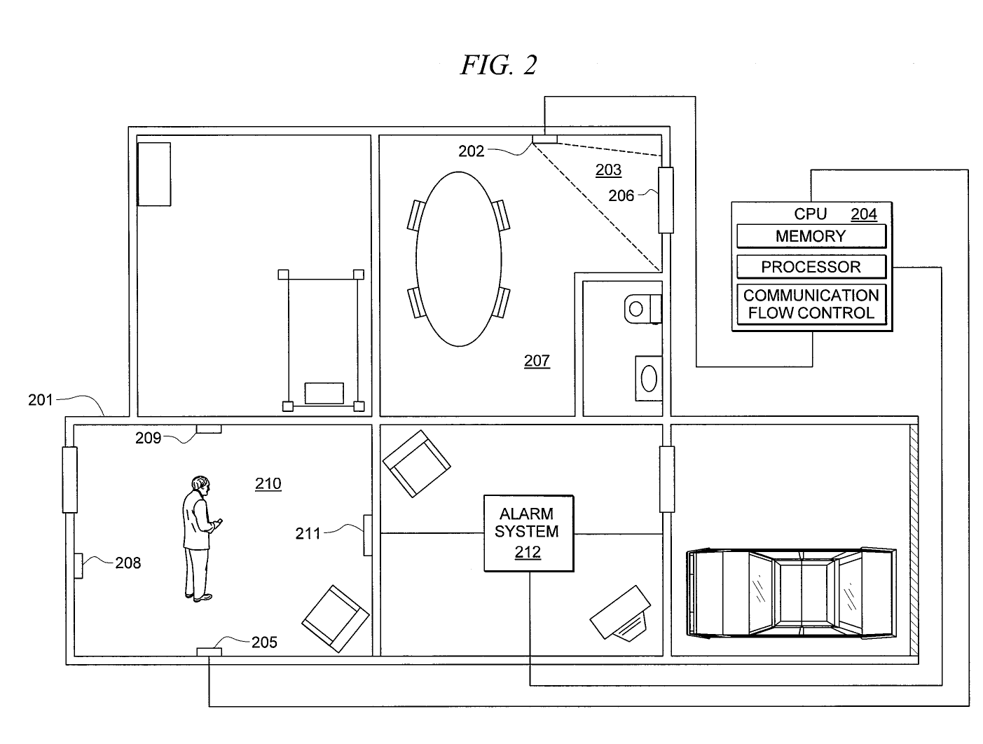

FIG. 2 illustrates how a plurality of utility outlets are used to effect one embodiment of the current invention. In FIG. 2, a building 201 is equipped with an alarm system 212. Alarm system 212 is capable of operating as but not limited to a fire alarm, a burglar alarm, a weather related alarm, a terrorist threat alarm and a chemical release alarm. Utility outlet 202 includes a camera and is positioned in a location to take images of area 203. Area 203 is in the vicinity of door 206. The images taken by utility outlet 202 are transmitted to CPU 204. CPU 204 processes these images and sends data of these images to utility outlet 205. CPU 204 may, if desired, store the images. Utility outlet 205 has a receiver capable of receiving data of the images. Additionally, utility outlet 205 has a projector capable of projecting an image of the received data. The projector may be, but is not limited to, a liquid crystal display (LCD) monitor and a digital light processing (DLP) monitor.

An example of how the system would operate is as follows. If someone enters building 201 through door 206, alarm system 212 will detect this and send a signal to CPU 204, In turn, CPU 204 sends a signal to utility outlet 202 to capture an image of area 203 because an image of area 203 is likely to contain the image of the person in room 207 who caused the alarm by entering through door 206. Utility outlet 202 then sends a signal of the captured image to CPU 204. CPU 204 then sends a signal of the image to utility outlet 205. Utility outlet 205 renders the image of area 203 on the projector located in utility outlet 205. Thus, an occupant of room 210 will be able to see who triggered the alarm system in area 203.

In another embodiment of the current invention, the signal image data from utility outlet 202 is sent to CPU 204. CPU 204 then sends a corresponding signal to utility outlets 205, 208 and 209. In this embodiment, utility outlets 205, 208 and 209 contain laser emitters. CPU 204 coordinates the emission of the laser beams from utility outlets 205, 208 and 209 to create a holographic image of area 203 on projector 211. Projector 211 may be any suitable device capable of rendering a holographic image such as a DLP or a digital micro-mirror device (DMD). Utility outlets 205, 208 and 209 are positioned to facilitate the creation of the holographic image on projector 211. The utility outlets could be chosen from a combination of a power socket, an electrical switch and a permanently mounted light socket.

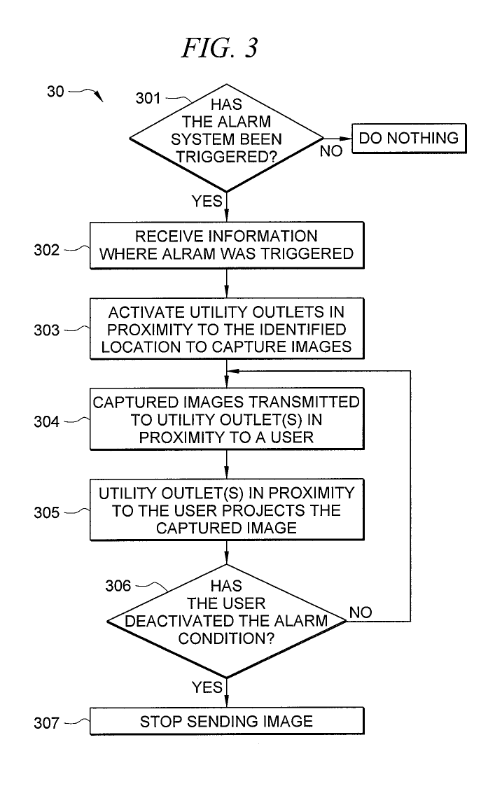

FIG. 3 shows one embodiment of the current invention illustrated by a flow chart 30. In process 301, the system asks whether the alarm system has been triggered. If the alarm system has not been triggered then the system does nothing. If the alarm system has been triggered, in process 302, the system receives information of the location where the alarm has been triggered. Then, in process 303, the system activates utility outlets in proximity to the identified location to capture images of the identified location. In process 304, captured images are transmitted to utility outlets in proximity to a user. The utility outlets in proximity to the user then projects the captured images for viewing by the user in process 305. The user, if satisfied that the cause of the alarm is not a threat, will deactivate the system. If not, the user will continue to monitor the images being presented by the utility outlets. Thus, process 306 asks whether the user has deactivated the system. If the system has not been deactivated, the system continues to send images to be viewed by the user in process 303. If the system has been deactivated then the system stops sending images in process 304.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of using a plurality of utility outlets in a premises to allow a user to view an image pertinent to an alarm condition, said method comprising:
connecting at least one device to said premises's electrical power with any of said plurality of utility outlets;
receiving, at a first of said plurality of utility outlets, an alarm condition signal;
in response to said alarm condition signal, said first utility outlet capturing said image; wherein said image is of an area relevant to said alarm condition signal; and
transmitting a signal of said image to a second of said plurality of utility outlets, said second utility outlet remote from said area.

2. The method of claim 1 wherein said alarm condition signal is in response to an alarm condition selected from the list consisting of:
a fire alarm, a burglar alarm, a weather related alarm, a terrorist threat alarm, a chemical release alarm.

3. The method of claim 1 further comprising:
receiving said transmitted signal at said second utility outlet; and
rendering said image from said second utility outlet.

4. The method of claim 3 wherein the image is projected from a component of said second utility outlet, said component selected from the list consisting of:
a liquid crystal display (LCD) monitor and a digital light processing (DLP) monitor.

5. The method of claim 1 further comprising:
storing said images.

6. The method of claim 1 further comprising:
receiving said transmitted signals at a second of said utility outlets, wherein said second utility outlet is remote from said area; and
producing, from said second utility outlet, laser light to create a holographic image of said area.

7. The method of claim 6 wherein said holographic image is rendered on a projector selected from the list consisting of:
a DLP projector and a digital micro-mirror device (DMD) projector.

8. A utility outlet for use within a premises, said utility outlet comprising:
means for connecting a device to said premises's electrical power; and
means for capturing an image.

9. The utility outlet of claim 8 wherein said utility outlet is one of the group consisting of:
a power socket, an electrical switch, a permanently mounted light socket.

10. The utility outlet of claim 8 further comprising:
means for rendering an image.

11. A utility outlet for use within a premises, said utility outlet comprising:
means for connecting a device to said premises's electrical power; and
means for rendering an image in response to a signal from another utility outlet.

12. The utility outlet of claim 11 wherein said utility outlet is one of the group consisting of:
a power socket, an electrical switch, a permanently mounted light socket.

13. A utility outlet for use within a premises, said utility outlet comprising:
terminals for connecting a device to said premises's electrical power; and
a camera, said camera adapted to receive power through said terminals.

14. A utility outlet for use within a premises, said utility outlet comprising:
terminals for connecting a device to said premises's electrical power, and
a projector, said projector adapted to receive power through said terminals.

15. The utility outlet of claim 14 wherein said projector is selected from the list consisting of:
a DLP projector and a DMD projector.

16. A utility outlet for use within a premises, said utility outlet comprising:
terminals for connecting a device to said premises's electrical power; and
at least one laser light emitter.

17. A system for allowing a user to view images pertinent to an alarm condition, said system comprising:
a plurality of utility outlets wherein a first of said utility outlets is capable of capturing an image of an area and a second of said utility outlets is capable of rendering said image of said area for viewing by a user remote from said area; and
a central processing unit.

18. The system of claim 17 wherein said central processing unit is located within one of said plurality of utility outlets.

19. The system of claim 17 wherein said central processing unit comprises a memory for storing said images.
